(19) United States
(12) Patent Application Publication
(10) Pub. No.: US 2026/0127304 A1
(43) Pub. Date: May 7, 2026

(54) DATA SECURITY FOR PROTECTING WEB CONTENT

(71) Applicant: CISCO TECHNOLOGY, INC., San Jose, CA (US)

(72) Inventor: Nickolay BELCHUGOV, Suresnes (FR)

(21) Appl. No.: 18/936,667

(22) Filed: Nov. 4, 2024

(51) Int. Cl. G06F 21/62; G06F 16/957; G06F 21/10

(52) U.S. Cl. CPC G06F 21/6218; G06F 16/9574; G06F 21/106; G06F 2221/2133; G06F 2221/2149

(57) ABSTRACT

In one embodiment, a method includes duplicating, by a processor, original web content accessible via a web application; scanning, by the processor, the original web content to identify protected content within the web content; replacing, by the processor, the protected content with metadata, wherein the metadata is accessible as part of limited web content via a duplicated web application; routing, by the processor, one or more non-human users to the duplicated web application and allowing access to the limited web content; and routing, by the processor, one or more human users to the web application and allowing access to the original web content.

### FIELD

The present disclosure relates to data security for web content and more particularly to data security to protect web content from improper access, such as improper automated access by web search engines and web archives.

### BACKGROUND

Web-hosted content runs on private or public cloud servers and is hosted by a web server. Websites are typically seen as web applications having multiple functionalities and tools that are integrated to offer dynamic web content. For example, multiple tools run in front of the web application. The functionalities of these tools include protection, rerouting, load-balancing, etc. However, improper automated content access (e.g., unauthorized copying of web content subject to intellectual property rights) can occur when allowing content to be indexed by web search engines and web archives even with the integrated functionalities and tools.

Accordingly, it is desirable to provide improved methods and systems for protecting web content from being improperly accessed and copied, such as by web search engines and web crawlers. Furthermore, other desirable features and characteristics of the present disclosure will become apparent from the subsequent detailed description and the appended claims, taken in conjunction with the accompanying drawings and the foregoing technical field and background.

### DRAWINGS

In order that the disclosure may be well understood, there will now be described various forms thereof, given by way of example, reference being made to the accompanying drawings, in which:

FIG. 1 is a block diagram illustrating an example of a web hosted system in accordance with various embodiments.

FIG. 2 is a block diagram illustrating a web content security system allowing different levels of exposed content in accordance with various embodiments.

FIG. 3 is a block diagram illustrating web content duplication in accordance with various embodiments.

FIG. 4 is a block diagram illustrating scanning of duplicated web content in accordance with various embodiments.

FIG. 5 is a block diagram illustrating metadata replacement of web content in accordance with various embodiments.

FIGS. 6A and 6B illustrate a block diagram showing routing of data traffic from different entities in accordance with various embodiments.

### DETAILED DESCRIPTION

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

According to various embodiments, systems, methods, and computer program products are provided for limiting access to web content. A method includes duplicating, by a processor, original web content accessible via a web application; scanning, by the processor, the original web content to identify protected content within the web content; replacing, by the processor, the protected content with metadata, wherein the metadata is accessible as part of limited web content via a duplicated web application; routing, by the processor, one or more non-human users to the duplicated web application and allowing access to the limited web content; and routing, by the processor, one or more human users to the web application and allowing access to the original web content.

### Example Embodiments

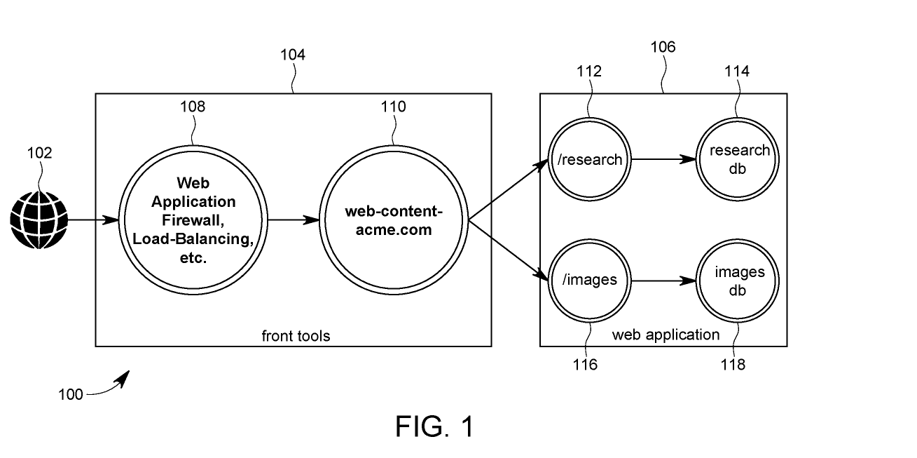

With reference to FIG. 1, an exemplary web hosted system is shown generally at 100 having one or more front tools 104 and a web application 106. The one or more front tools 104 run in front of the web application 106 (e.g., operate in front of a web server) and control dynamic web content accessible from the web application 106. The web hosted system 100 is configured to allow web crawling used by external entities (e.g. search engines) to gather data in a controlled environment. That is, different levels of web crawling access are provided that allows access, for example, by the web crawlers (e.g., search engines and generative Artificial Intelligence (AI)) to desired content while preventing access to and copying of other content (e.g., prevent unauthorized copying by bots of web content subject to one or more intellectual property rights) when web crawling is being performed to gather information via the web 102. As such, limited content access by non-human users can be provided to the web application 106, while also providing a different level of content access to human users that is not limited, thereby improving the overall user experience and security of the web application 106.

The web hosted system 100 in various embodiments includes or is implemented using, for example, one or more servers that are communicatively coupled to one or more computer systems through a network. In some embodiments, the one or more computer systems connect to the network (e.g., cloud network) through different means. The one or more computer systems generally operate with any sort of conventional processing hardware, including, but not limited to, at least one processor, memory, an operating system, and an input/output device.

The processor(s) may be implemented using any suitable processing system, such as one or more processors, controllers, microprocessors, microcontrollers, processing cores and/or other computing resources spread across any number of distributed or integrated systems, including any number of “cloud-based” or other virtual systems. The memory represents any non-transitory short- or long-term storage or other computer-readable media capable of storing programming instructions for execution on the processor(s) including any sort of random-access memory (RAM), read only memory (ROM), flash memory, magnetic or optical mass storage, and/or the like. The computer-executable programming instructions, when read and executed by the processor(s) cause the processor(s) to create, generate, or otherwise facilitate the communication of content and perform one or more additional tasks, operations, functions, and/or processes described herein. In various embodiments, the memory includes at least a portion of the front tools 104 or other controller and the memory includes one or more databases that store content as described in more detail herein. As can be appreciated, the memory represents one suitable implementation of such computer-readable media, and alternatively or additionally, the processor(s) can receive and cooperate with external computer-readable media that is realized as a portable or mobile component or application platform, e.g., a portable hard drive, a USB flash drive, an optical disc, or the like.

Each of the one or more computer systems generally includes any sort of personal computer, mobile telephone, tablet, or other network-enabled client device on the network. The computer system generally operates with any sort of conventional processing hardware, including but not limited to, at least one processor, memory, an operating system, and input/output devices. The processor may be implemented using any suitable processing system, such as one or more processors, controllers, microprocessors, microcontrollers, processing cores and/or other computing resources spread across any number of distributed or integrated systems, including any number of “cloud-based” or other virtual systems.

In an exemplary embodiment, the computer system includes or communicates with a display device, such as a monitor, screen, or another conventional electronic display capable of presenting the web content retrieved from the server system or other internet device via the network.

According to one or more use cases, and for example, a user operates a conventional application (e.g., browser application) or other client program such as an application executed by the computer system to contact the server system via the network using a networking protocol, such as the hypertext transport protocol (HTTP) or the like. Web content is then presented and viewed by the user, as desired, via the display device or other means. In various embodiments, different levels of filtered web content are made available to different types of users, such as different levels of filtered web content being presented to human users and non-human users as described in more detail herein.

With particular to reference to the illustrated example shown in FIG. 1, the front tools 104 include one or more security devices 108 (or other mechanisms) that are configured to monitor and control the flow of traffic between the web 102 and the web application 106 (e.g., between one or more networks associated with the web 102 and one or more devices associated with the web application 106). For example, the one or more security devices 108 monitor crawling activity to protect unauthorized access to portions of the data accessible from the web application 106. The one or more security devices 108 can be any type of device, such as a web application firewall, load-balancing device, etc. that monitors data traffic and applies a set of security rules to determine whether to allow access to web application content (illustrated as web content 110), which as described in more detail herein, can include different types of content of the web application 106 (e.g., filtering information accessible by bots). That is, various embodiments permit authorized traffic access to different types or classifications of web content 110. It should be noted that the one or more security devices 108 can be implemented in hardware, software, and/or a virtual cloud to inspect network packets and apply the set of security rules.

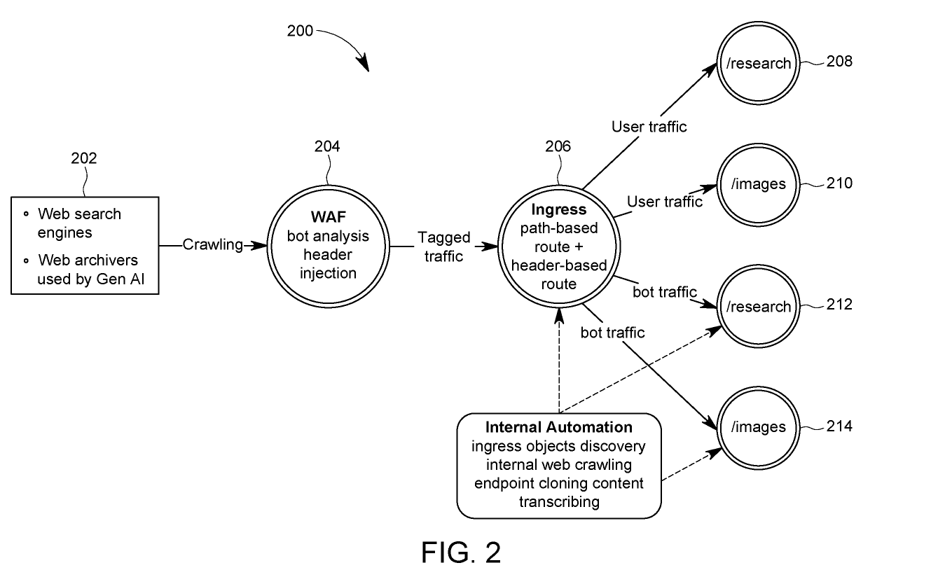

With reference now also to FIG. 2 showing a web content security system 200 in accordance with various embodiments. As can be seen, web crawling at 202 can be performed by different entities, such as web search engines and web archivers used by generative AI (collectively referred to as “web crawlers”). The web crawlers access public Domain Name System (DNS) servers and use DNS lists to discover publicly available websites or web applications (e.g. the web content 110 illustrated as web-content-acme.com). For each website, the web crawlers or other non-human users attempt to access the sub-pages 112, 116 (e.g. web-content-acme.com/research 112, web-content-acme.com/images 116). Access to the sub-pages 112, 116 allows for web crawling data 114, 118 (from a research database (db) and an images db) to be extracted. The extracted data can be, for example, text-based, image-based, video-based, etc. The extracted data is indexed with the indexes used by web search engines or web archivers. The content can be used, for example, by generative AI to build content, which could otherwise be based on intellectual property protected data extracted when performing the web crawling without implementation of one or more of the herein described embodiments.

In various embodiments, a web application firewall (WAF) 204 monitors incoming and outgoing data packets for the web application 106, which allows for filtering the available web content 110 provided to the different entities or users, such as search engines and generative AI using web crawling to gather information (e.g., bots search for new or updated content) from the web 102 as described in more detail herein. The WAF 204 is configured to distinguish between human users and automated programs, such as bots. As described in more detail herein, in various embodiments, instead of blocking the bots from all the web content 110, information to the bots is filtered, such that the bots are allowed access to portions of the web content 110. As such, visibility to the web application 106 can be increased in various embodiments.

More particularly, hybrid blocking or filtering is performed in accordance with various embodiments, such that human and non-human traffic is allowed to pass through one or more security tools, including the WAF 204. As described in more detail below, human traffic is routed to full user experience web content and non-human traffic is routed to filtered or limited web content. That is, human traffic and non-human traffic are routed to web content 110 having different levels of filtering. For example, an ingress controller 206 is configured to route data traffic differently, which may be based on a path-based route and a header-based route. In one embodiment, human traffic (indicated as user traffic in FIG. 2) is routed to sub-pages 208, 210 to access research data and image data in the illustrated example. Non-human traffic (indicated as bot traffic) is routed to sub-pages 212, 214 to access research data and image data in the illustrated example. As should be appreciated, the data available from the sub-pages 208, 210 is different than the data available from the sub-pages 212, 214. As should also be appreciated, in various embodiments, internal automation may be provided, such as by ingress object discovery, internal web crawling, endpoint cloning, content transcribing, etc.

In various embodiments, the web content security system 200 uses bot detection, bot traffic packages tagging, web traffic rerouting based on tags, content discovery, content cloning, and/or content transcribing to perform routing of crawling traffic (e.g., routing of tagged crawling traffic). For example, bot operations, such as bot detection, can be performed by the WAF 204 or the ingress controller 206. It should be noted in embodiments wherein bot detection is performed by the WAF 204, bot traffic tagging is used such that the ingress controller 206 employs tags (e.g. available as Hypertext Transfer Protocol (HTTP) headers) to route user (human) traffic to original endpoints and bot traffic to transcribed data or other filtered data as described in more detail herein.

It should be noted that in some examples, automation is used to discover endpoints and associated content, clone the content, and transcribe the content (and/or remove some of the content). For example, in various embodiments, filtered web content is initially a duplication of the original web content, and based on administrator parameters, parts or portions of web pages are removed or transcribed into metadata. The metadata in one or more embodiments contains limited but sufficient information of the original object to describe the original web content (e.g., the web content 110). The transcription process can be performed using any suitable method, which includes using, for example, object detection, a paraphraser, a summarizer, etc.

More particularly, using a photography website as an example, user traffic is routed to original content with photos. Bot traffic is routed to transcribed data that describes the original content with text instead of providing the image itself. For example, the bot traffic or other non-human traffic is routed to a duplicated website having text maintained and images subject to one or more intellectual property rights replaced with text describing the images. In some embodiments, the images subject to one or more intellectual property rights are removed entirely.

As another example, for a website that hosts published documents, such as scientific papers, user traffic is routed to original content with full text of the scientific papers. Bot traffic is routed to modified or filtered content having shorter versions of the scientific papers. For example, the bot traffic or other non-human traffic is routed to a duplicated website having shorter (e.g., shorter versions of the text) or redacted versions of the original scientific papers that do not violate one or more intellectual property rights relating to the scientific papers. That is, the scientific papers are modified, such that copying of the content associated with the scientific papers is allowed. It should be appreciated that the papers can be, for example, any written papers or documents subject to one or more intellectual property rights. It should also be appreciated that the various embodiments described herein can be implemented in connection with any content, such as hosted by a website, that includes some or all of the content being subject to one or more intellectual property rights.

Other operations and/or functions can be performed, as well, using different methods. For example, the content discovery, content cloning, and content transcribing can be performed using a descriptive model-based environment (e.g., Kubernetes and Kubernetes Operators) or using web proxies having caching. It should be appreciated that any of the operations and/or functions can be performed using different suitable means and technologies.

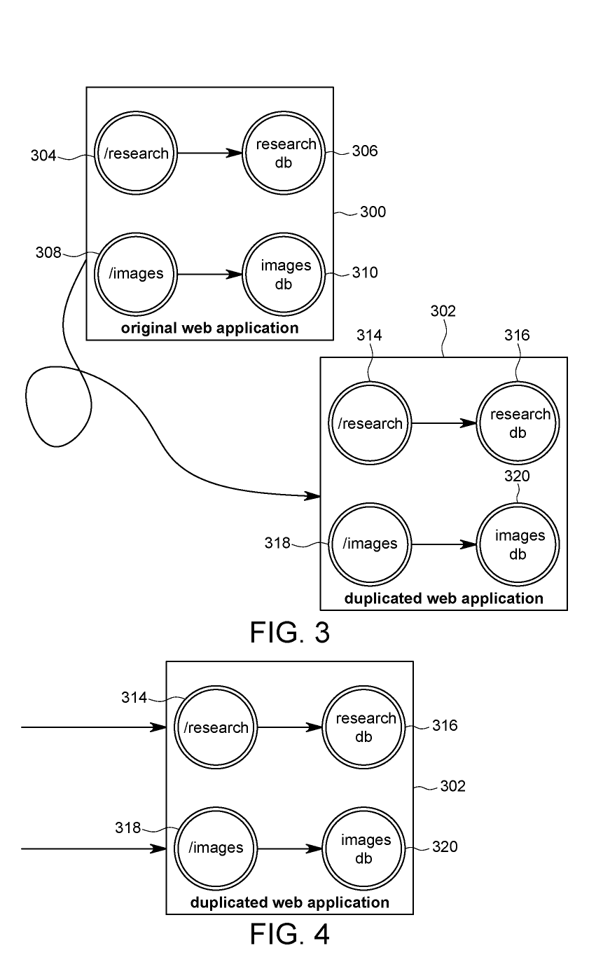

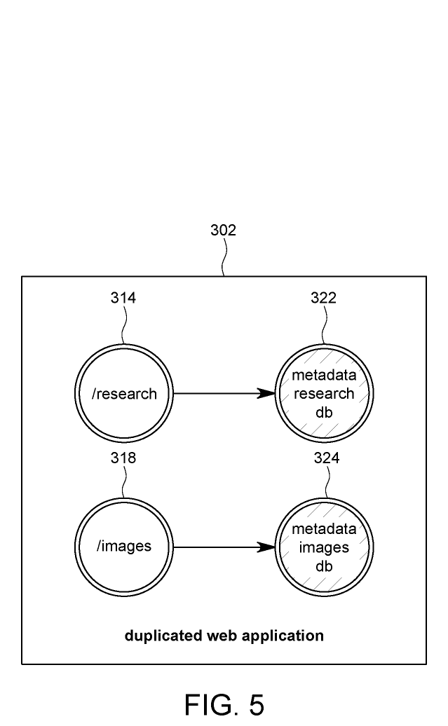

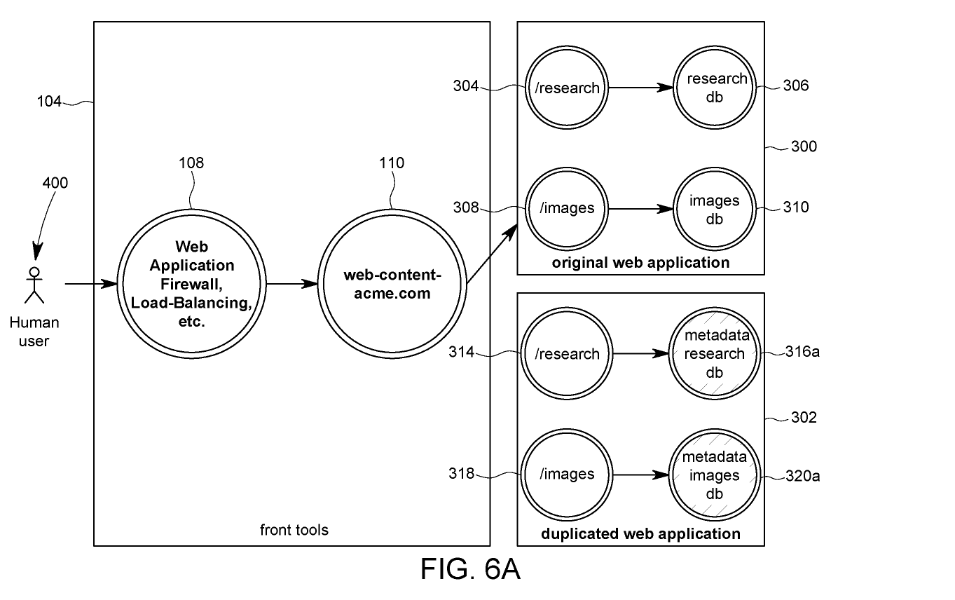

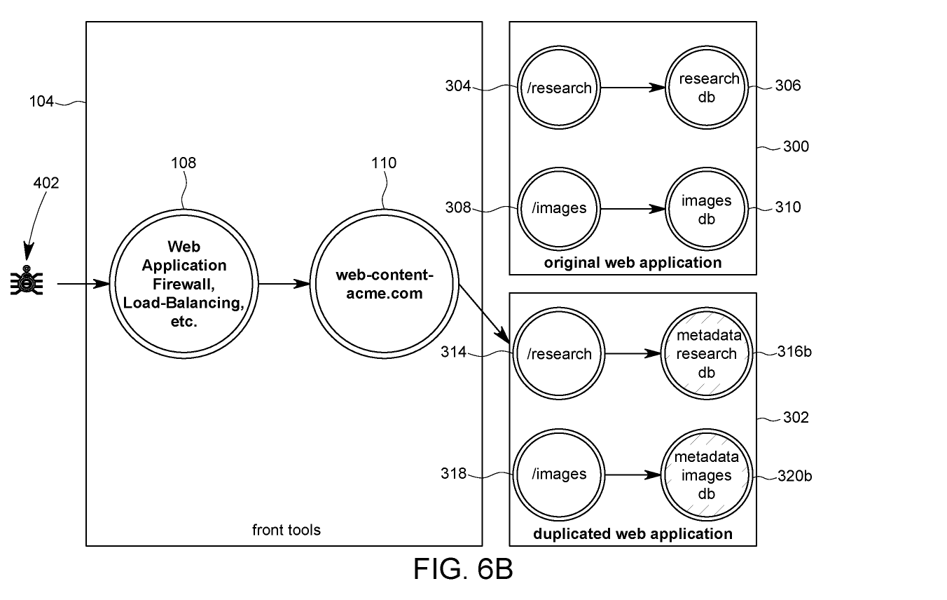

With reference now to FIG. 3-6, FIG. 3 illustrates web content duplication in accordance with various embodiments, FIG. 4 illustrates scanning of duplicated web content in accordance with various embodiments, FIG. 5 illustrates metadata replacement of web content in accordance with various embodiments, and FIGS. 6A and 6B illustrate routing of data access by different entities in accordance with various embodiments. As can be seen, a web application 300 (which may be embodied as or form part of the web application 106) provides access to sub-pages 304, 308 (e.g. embodied as web-content-acme.com/research 112, web-content-acme.com/images 116) that allows for data traffic to and from a research db 306 and an images db 310 (e.g., embodied as the research db 114 and the research db 118). This original content of the web application 300 is duplicated, shown as a duplicated web application 302. The duplicated content includes sub-pages 314, 318, which are copies of the sub-pages 304, 308, and a research db 316a and an images db 320a, which are copies of the research db 306 and the images db 310. That is, the sub-pages and associated web-content are duplicated and stored.

The duplicated content of the duplicated web application 302 is scanned (illustrated by the arrows in FIG. 4). For example, the duplicated content is scanned to identify any protected content, such as content protected by intellectual property rights (e.g., photographs or images) or other rights, such that copying of the content is to be restricted or limited. That is, in various embodiments, the identified content is marked as protected and access (e.g., bot crawling access) to the content is restricted or limited. The identification of the protected content can be performed using any suitable detection and/or analysis means, such as using object detection, content detection, intellectual property marking detection, content analysis, etc.

As can be seen in FIG. 5, the identified content of the sub-pages 314, 318, such as content protected by one or more intellectual property rights, is replaced with metadata 322, 324. That is, the original content that was identified as content to be protected, which in various embodiments is protection from automated web crawling or other automated web archiving, is replaced with metadata describing the original content. For example, the metadata 322 corresponds to data of the research db 316b and the metadata 324 corresponds to the data of the images db 320b. It should be appreciated that the metadata 322, 324 can be any information that describes the original data, including the original data in the sub-pages 314, 318. For example, the metadata 322, 324 can describe the structure, content, context, etc. of the original data in the sub-pages 314, 318.

With the original data duplicated, and being modified or filtered to remove protected content and replace the protected content with the metadata 322, 324, routing of data traffic from different entities can be performed as shown in FIGS. 6A and 6B. As can be seen, original and limited web content are hosted and become available on the web server. That is, the front tools 104 are configured to detect human users 400 and non-human users 402 (e.g., web crawlers or other non-human automated activity performed, such as via an Application Programming Interface (API) or via a non-API interface using a script or other non-human source).

The detection of human users 400 and non-human users 402 can be performed using any suitable means. For example, one or more embodiments analyze the data traffic to identify activity and/or access patterns that suggest bot/crawler behavior, rather than real human behavior. In some embodiments, crawler/bot activity is detected as non-human activity performed, such as via an API or via a non-API interface. Crawler/bot activity is detected as non-API activity performed by a script or other non-human source. For example, a crawler/bot (e.g., an “Internet Bot” or “web robot”) may be detected by the presence of an autonomous software application that is running automated tasks over a network.

In operation, the human users 400 are routed to the original content accessible with the original web application 300 and the non-human users 402 are routed to the limited web content accessible with the duplicated web application 302. As should be appreciated, the limited web content in various embodiments is machine-readable, thereby allowing the web content to be used for indexing.

Thus, various embodiments combine and customize security and routing tools (e.g., layer-7 security and routing tools), thereby allowing "positive" crawling and preventing “negative” crawling.

The various embodiments can be implemented in different operating environments that facilitate the performance of the systems and methods described herein. For example, the systems and methods described herein, including the components, processors, servers, etc. can be implemented on a computing device. For example, the computing device can be a personal computer, a desktop, a laptop, a tablet, a hand-held computer, a server, a workstation, a mainframe, a wearable computer, a supercomputer, or a combination thereof. However, it is understood that the aforementioned examples of what the computing device may be is non-exhaustive and that the computing device can be any related device. The computing device generally includes a processor, a display adapter, one or more input/output port(s), one or more input/output component(s), a network adapter, a power supply, and a memory. However, it is understood that the computing device can include any additional components therein and is not required to include any of the listed components (e.g., the processor, the display adapter, the one or more input/output port(s), the one or more input/output component(s), the network adapter, the power supply, and the memory).

The processor is configured to provide instructions and/or processing power to the computing device so that the computing device can process one or more tasks including the implementation of a software program. It is also understood that the computing device may include any number or processors therein. The display adapter can be a graphics card or a video board that provides the computing device with a capability to display content on a display device. For example, the display device can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device may be is non-exhaustive and that the display device can be any related device.

The input/output port(s) provides a number of sockets for one or more cables to connect to the computing device. It is understood that there may be any number of input/output port(s) on the computing device. For example, the input/output port(s) provides a means for the computing device to receive signals and/or data from an external device connected to the computing device via the one or more cables. As another example, the input/output port(s) provides a means for the computing device to send signals and/or data from an external device connected to the computing device via the one or more cables. The input/output component(s) can include one or more components that support the input/output port(s) such as, but not limited to, a switch, a push button, a pressure mat, a float switch, a keypad, a radio receive, or a combination thereof.

A network adapter can be a network interface controller that is configured to provide a means for communicating over a network. The power supply is configured to convert alternating high voltage current (e.g., AC) into direct current (e.g., DC) to provide regulated power to the other components (e.g., the processor, the display adapter, the one or more input/output port(s), the one or more input/output component(s), the network adapter, and the memory) of the computing device.

Additionally, the memory can be a mass storage device and/or a system memory such as a hard disk drive, a memory card, a solid-state drive, random access memory (RAM), or a combination thereof. The memory is configured to provide a holding place for instructions and data associated with the operation of the computing device. The memory can generally include an operating system. For example, the operating system is configured to process any of the data and/or instructions associated therewith as described in more detail herein.

The operating system(s) includes computer-executable programming instructions, when read and executed by the processor(s) cause the processor(s) to operate the computer system’s basic functions such as operations of the front tools 104, executing applications, memory allocation, and controlling input/output devices. The input/output devices generally represent the interface(s) to one or more networks (e.g., any network, or any other local area, wide area, or other network), mass storage, display devices, data entry devices, and/or the like.

Furthermore, a system bus is also included within the computing device that is configured to couple each of the various components (e.g., the processor, the display adapter, the one or more input/output port(s), the one or more input/output component(s), the network adapter, the power supply, and the memory) of the computing device.

In various embodiments, the network can include interconnected network nodes that are arranged according to one or more of a variety of network topologies and that are configured to communicate data according to one or more communication protocols. The network nodes can include, for example, network interface controllers, repeaters, hubs, bridges, switches, routers, firewalls, modems, etc. The network nodes may be interconnected based on physically wired, optical, and/or wireless topologies.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, computer-readable storage medium (tangible medium) are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs and/or cause one or more processors to perform one or more particular functions. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for limiting access to web content, the method comprising:
duplicating, by a processor, original web content accessible via a web application;
scanning, by the processor, the original web content to identify protected content within the original web content;
replacing, by the processor, the protected content with metadata, wherein the metadata is accessible as part of limited web content via a duplicated web application;
routing, by the processor, one or more non-human users to the duplicated web application and allowing access to the limited web content; and
routing, by the processor, one or more human users to the web application and allowing access to the original web content.

2. The method of claim 1, wherein the protected content comprises web content subject to one or more intellectual property rights.

3. The method of claim 2, wherein the web content subject to one or more intellectual property rights is replaced with web content not subject to one or more intellectual property rights including the metadata.

4. The method of claim 2, wherein the web content subject to one or more intellectual property rights is removed from the duplicated web application.

5. The method of claim 2, wherein the web application comprises a photography website and the protected content comprises one or more images subject to the one or more intellectual property rights, and further comprising replacing the one or more images subject to the one or more intellectual property rights with text describing the one or more images.

6. The method of claim 2, wherein the web application comprises a photography website and the protected content comprises one or more images subject to the one or more intellectual property rights, and further comprising removing the one or more images subject to the one or more intellectual property rights.

7. The method of claim 2, wherein the web application comprises a document website and the protected content comprises one or more published documents subject to the one or more intellectual property rights, and further comprising replacing one or more portions of the one or more published documents subject to the one or more intellectual property rights with a shorter version of text of the one or more published documents.

8. The method of claim 2, wherein the web application comprises a document website and the protected content comprises one or more published documents subject to the one or more intellectual property rights, and further comprising removing the one or more published documents subject to the one or more intellectual property rights.

9. The method of claim 1, wherein the limited web content is machine-readable and configured to allow indexing of the limited web content.

10. The method of claim 1, wherein non-human users comprise one or more of a web search engine and a web archiver using a web crawler.

11. A system for limiting access to web content, the system comprising:
one or more processors;
a tangible computer-readable storage medium storing instructions which, when executed by the one or more processors, cause the one or more processors to:
duplicate original web content accessible via a web application;
scan the original web content to identify protected content within the web content;
replace the protected content with metadata, wherein the metadata is accessible as part of limited web content via a duplicated web application;
route one or more non-human users to the duplicated web application and allowing access to the limited web content; and
route one or more human users to the web application and allowing access to the original web content.

12. The system of claim 11, wherein the protected content comprises web content subject to one or more intellectual property rights.

13. The system of claim 12, wherein the web content subject to one or more intellectual property rights is replaced with web content not subject to one or more intellectual property rights including the metadata.

14. The system of claim 12, wherein the web content subject to one or more intellectual property rights is removed from the duplicated web application.

15. The system of claim 12, wherein the web application comprises a photography website and the protected content comprises one or more images subject to the one or more intellectual property rights, and the tangible computer-readable storage medium storing instructions which, when executed by the one or more processors, further cause the one or more processors to replace the one or more images subject to the one or more intellectual property rights with text describing the one or more images.

16. The system of claim 12, wherein the web application comprises a photography website and the protected content comprises one or more images subject to the one or more intellectual property rights, and the tangible computer-readable storage medium storing instructions which, when executed by the one or more processors, further cause the one or more processors to remove the one or more images subject to the one or more intellectual property rights.

17. The system of claim 12, wherein the web application comprises a document website and the protected content comprises one or more published documents subject to the one or more intellectual property rights, and the tangible computer-readable storage medium storing instructions which, when executed by the one or more processors, further cause the one or more processors to replace one or more portions of the one or more published documents subject to the one or more intellectual property rights with a shorter version of text of the one or more published documents.

18. The system of claim 12, wherein the web application comprises a document website and the protected content comprises one or more published documents subject to the one or more intellectual property rights, and the tangible computer-readable storage medium storing instructions which, when executed by the one or more processors, further cause the one or more processors to remove the one or more published documents subject to the one or more intellectual property rights.

19. The system of claim 11, wherein the limited web content is machine-readable and configured to allow indexing of the limited web content by the non-human users, and wherein the non-human users comprise one or more of a web search engine and a web archiver using a web crawler.

20. A method of filtering web traffic, the method comprising:
filtering, by a processor, non-human web traffic and routing the filtered non-human web traffic to a duplicated web application to access limited web content, wherein the limited web content comprises duplicated web content based on original web content having protected content replaced with metadata; and
filtering, by the processor, human web traffic and routing the filtered human web traffic to a web application allowing access to the original web content.
